(19) United States
(12) Patent Application Publication
(10) Pub. No.: US 2025/0362842 A1
(43) Pub. Date: Nov. 27, 2025

(54) MANAGEMENT SYSTEM INCLUDING CONSUMING DEVICE CONSUMING CONSUMABLE AND SERVER MANAGING DELIVERY OF CONSUMABLE AND METHOD OF MANAGING MANAGEMENT SYSTEM

(71) Applicant: BROTHER KOGYO KABUSHIKI KAISHA, Nagoya (JP)

(72) Inventors: Taichiro KIMOTO, Nagoya (JP); Koichi TSUGIMURA, Nagoya (JP); Yutaka TAKIJIRI, Nagoya (JP)

(73) Assignee: BROTHER KOGYO KABUSHIKI KAISHA, Nagoya (JP)

(21) Appl. No.: 19/219,572

(22) Filed: May 27, 2025

(30) Foreign Application Priority Data
May 27, 2024 (JP) 2024-085597
May 16, 2025 (JP) 2025-082446

(51) Int. Cl. G06F 3/12; G06Q 10/083

(52) U.S. Cl. CPC G06F 3/121; G06F 3/1207; G06F 3/1219; G06F 3/1259; G06Q 10/083; G06F 3/1288

(57) ABSTRACT

A management system includes: a consuming device and a server. At least one of the consuming device and the server is configured to perform: a delivery requesting process; an obtaining process; a determination process; and a notification process. The delivery requesting process includes issuing a delivery request for a new contract consumable. The obtaining process includes obtaining delivery information and provision information. The delivery information indicates a delivery status of the new contract consumable. The provision information indicates a provision status of the new contract consumable that has been delivered. The determination process includes determining whether an unused contract consumable that has been delivered exists based on the delivery information and the provision information. The notification process is performed in response to determining in the determination process that the unused contract consumable exists and includes outputting a notification prompting use of the unused contract consumable with the consuming device.

### REFERENCE TO RELATED APPLICATIONS

This application claims priorities from Japanese Patent Application No. 2024-085597 filed on May 27, 2024 and Japanese Patent Application No. 2025-082446 filed on May 16, 2025. The entire content of each of these priority applications is incorporated herein by reference.

### BACKGROUND ART

A known technology relates to a service in which a manufacturer automatically delivers unused consumables to users on the basis of the usage status of consumables loaded into (provided to) the users' image-forming devices, for example. According to the known technology, even if users cancel their service agreements and the agreements are not currently in effect, users can continue to use the contract consumables delivered while their service agreements are in effect.

### SUMMARY

However, the known technology described above does not describe any process for handling cases in which delivered consumables remain in the user's possession in an unused state and, consequently, users cannot be prompted to load (provide) the unused consumables promptly.

In view of the foregoing, it is an object of the present disclosure to provide a management system, a consuming device, a server, and a method of managing the management system that can prompt loading (provision) of consumables when delivered consumables remain unused in the user's possession.

In order to attain the above and other objects, according to one aspect, the present disclosure provides a management system. The management system includes: a first consuming device; and a server. A consumable can be provided to the first consuming device. The server is configured to perform delivery management of the consumable under an agreement. The first consuming device is configured to perform: a consuming process. The consuming process includes consuming contract consumable provided to the first consuming device. The contract consumable is subject to the delivery management under the agreement for the first consuming device. At least one of the first consuming device and the server is configured to perform: a delivery requesting process; a delivery information storing process; a provision information storing process; an obtaining process; a determination process; and a notification process. The delivery requesting process incudes issuing a delivery request for a new contract consumable. The delivery information storing process includes storing delivery information indicating a delivery status of the new contract consumable corresponding to the delivery request issued in the delivery requesting process. The provision information storing process includes storing provision information indicating a provision status of the new contract consumable that has been delivered. The obtaining process includes obtaining the delivery information stored in the delivery information storing process and the provision information stored in the provision information storing process. The determination process includes determining whether an unused contract consumable that has been delivered exists based on the delivery information and the provision information obtained in the obtaining process. The notification process is performed in response to determining in the determination process that unused contract consumable exists. The notification process includes outputting a notification prompting use of the unused contract consumable with the first consuming device.

The management system according to the above aspect determines in the determination process whether the user possesses a delivered but unused contract consumable, and when determining in the determination process that a delivered but unused contract consumable exists, outputs a notification in the notification process prompting use of the delivered but unused consumable. Through the notification process, the first consuming device can effectively utilize unused consumables by prompting the user to use of delivered but unused consumables.

According to another aspect, the present disclosure also provides a consuming device. The consuming device is communicable with a server. The server is configured to perform delivery management of a consumable under an agreement. The consumable can be provided to the consuming device. The consuming device includes: a controller. The controller is configured to perform: a consuming process; a delivery requesting process; a delivery information storing process; a provision information storing process; an obtaining process; a determination process; and a notification process. The consuming process incudes consuming a contract consumable provided to the consuming device. The contract consumable is subject to the delivery management under the agreement for the consuming device. The delivery requesting process includes issuing a delivery request for a new contract consumable. The delivery information storing process includes storing delivery information indicating a delivery status of a new contract consumable corresponding to the delivery request issued in the delivery requesting process. The provision information storing process includes storing provision information indicating a provision status of the new contract consumable that has been delivered. The obtaining process includes obtaining the delivery information stored in the delivery information process and the provision information stored in the provision information storing process. The determination process includes determining whether an unused contract consumable that has been delivered exists based on the delivery information and the provision information obtained in the obtaining process. The notification process is performed in response to determining in the determination process that the unused contract consumable exists. The notification process includes outputting a notification prompting use of the unused contract consumable with the consuming device.

The consuming device according to the above aspect can effectively utilize unused consumables by outputting a notification prompting use of the delivered but unused consumable.

According to still another aspect, the present disclosure further provides a server. The server is communicable with a consuming device. A consumable can be provided to the consuming device. The sever is configured to perform delivery management of the consumable under an agreement. The consuming device is configured to perform a consuming process. The consuming process includes consuming a contract consumable provided to the consuming device. The contract consumable is subject to the delivery management under the agreement for the consuming device. The server includes: a controller. The controller is configured to perform: a delivery requesting process; a delivery information storing process; a provision information storing process; an obtaining process; a determination process; and a notification process. The delivery requesting process includes issuing a delivery request for a new contract consumable. The delivery information storing process includes storing delivery information indicating a delivery status of a new contract consumable corresponding to the delivery request issued in the delivery requesting process. The provision information storing process includes storing provision information indicating a provision status of the new contract consumable that has been delivered. The obtaining process includes obtaining the delivery information stored in the delivery information storing process and the provision information stored in the provision information storing process. The determination process includes determining whether an unused contract consumable that has been delivered exists based on the delivery information and the provision information obtained in the obtaining process. The notification process is performed in response to determining in the determination process that the unused contract consumable exists. The notification process includes outputting a notification prompting uses of the unused contract consumable with the consuming device.

The server according to the above aspect can effectively utilize unused consumables by outputting a notification prompting use of the delivered but unused consumable.

According to still another aspect, the present disclosure also provides a method of managing a management system. The management system includes: a consuming device; and a server. A consumable can be provided to the consuming device. The server is configured to perform delivery management of the consumable under an agreement. The method includes: the consuming device performing: a consuming device; and at least one of the consuming device and the server performing: a delivery requesting process; a delivery information storing process; a provision information storing process; an obtaining process; a determination process; and a notification process. The consuming process including consuming a contract consumable provided to the consuming device. The contract consumable is subject to the delivery management under the agreement for the consuming device. The delivery requesting process includes issuing a delivery request for a new contract consumable. The delivery information storing process includes storing delivery information indicating a delivery status of the new contract consumable corresponding to the delivery request issued in the delivery requesting process. The provision information storing process includes storing provision information indicates a provision status of the new contract consumable that has been delivered. The obtaining process includes obtaining the delivery information stored in the delivery information storing process and the provision information stored in the provision information storing process. The determination process includes determining whether an unused contract consumable that has been delivered exists based on the delivery information and the provision information obtained in the obtaining process. The notification process is performed in response to determining in the determination process that the unused contract consumable exists. The notification process includes outputting a notification prompting use of the unused contract consumable with the consuming device.

The present disclosure can also be implemented in various forms other than the management system. For example, the present disclosure can be realized in the form of a set of computer-readable instructions or a non-transitory computer-readable storage medium storing the set of computer-readable instructions.

### BRIEF DESCRIPTION OF DRAWINGS

FIG. 1 is a block diagram illustrating a schematic configuration of a management system.

FIG. 2 is a diagram illustrating a storage table stored on a printing device.

FIG. 3 is a flowchart illustrating steps in a main process performed on the printing device.

FIG. 4 is a flowchart illustrating steps in a cartridge delivery necessity checking process.

FIG. 5 is a flowchart illustrating steps in a cartridge delivery process.

FIG. 6 is a flowchart illustrating steps in a cartridge replacement process.

FIG. 7 is a flowchart illustrating steps in a cancellation process.

FIG. 8 is a flowchart illustrating steps in a replacement information storage process.

FIGS. 9A and 9B are diagrams illustrating a storage table of management information stored on a management server.

FIG. 10 is a flowchart illustrating steps in a pre-replacement information obtaining process.

### DESCRIPTION

Next, embodiments of the present disclosure will be described while referring to the accompanying drawings.

### First Embodiment

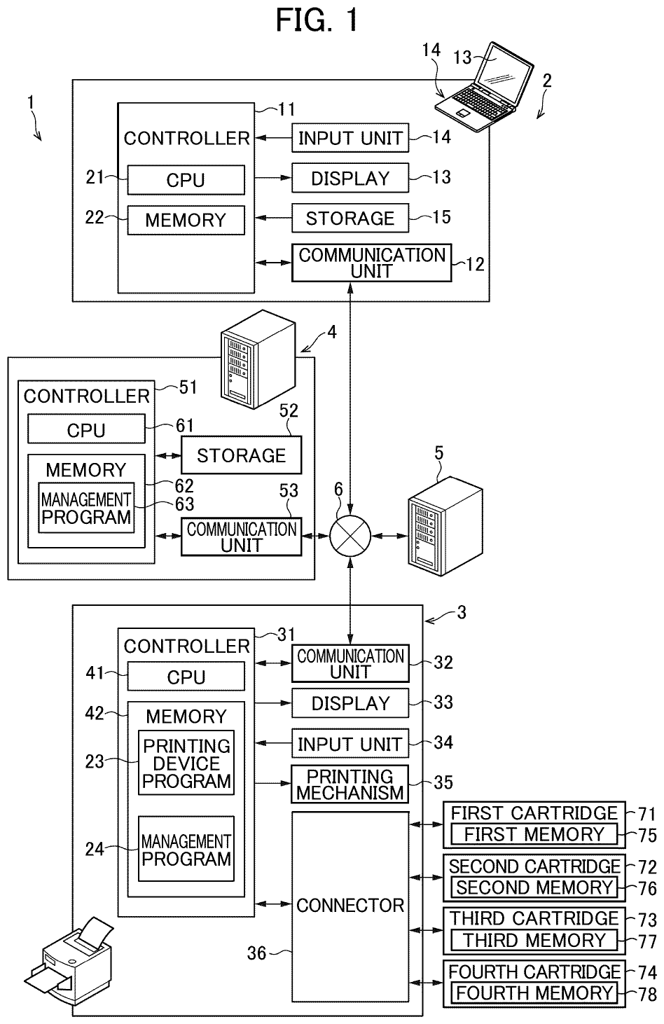

A management system 1 according to a first embodiment of the present disclosure will be described with reference to FIGS. 1 through 7.

[Overall Configuration of the Management System 1]

FIG. 1 is a block diagram illustrating the schematic configuration of the management system 1 according to the first embodiment of the present disclosure. As illustrated in FIG. 1, the management system 1 includes a terminal device 2, a printing device 3, a management server 4, and a delivery server 5, which are configured to communicate with each other over a WAN 6. WAN is an abbreviation for “wide area network.” In the present embodiment, the WAN 6 is the Internet.

In response to a request transmitted from the terminal device 2 to initiate a delivery service (service start request), the management server 4 of the management system 1 enters into an agreement (contract) for the printing device 3 and begins providing and managing the delivery service under the agreement. Specifically, when the management server 4 receives a service start request transmitted from the terminal device 2, the management server 4 transmits a request to the terminal device 2 for information on the user entering into the agreement and information on the printing device 3 to be the subject of the agreement. Upon receiving information on the user and information on the printing device 3 from the terminal device 2, the management server 4 stores the information on the user and the information on the printing device 3 in a storage 52. Subsequently, the management server 4 instructs the printing device 3 to change the mode of the printing device 3 to a contract mode. Upon receiving the instruction to change the mode from the management server 4, the printing device 3 switches the mode from a normal mode to the contract mode. The modes of the printing device 3 will be described later in greater detail. The printing device 3 and the user of the printing device 3 will be considered to be “under agreement” once the agreement has been entered into with the user for the printing device 3 and during the period in which the agreement remains valid and in effect.

The delivery service charges users based on the amount of printing performed during each service period under the agreement. The delivery service includes a service for automatically delivering ink cartridges 7 (hereinafter simply called “cartridges 7”) that can be used on the printing device 3, and a billing service for charging the user based on the number of printed pages, i.e., the number of pages of printing media that have been printed on the printing device 3. According to the present embodiment, each time the residual quantity of ink in one of the contract cartridges 7 (described later) loaded into the printing device 3 falls to a first threshold value or below, a replacement contract cartridge of the same type is delivered to the user.

The cartridges 7 in the present embodiment fall into one of two classifications: commercial cartridges and contract cartridges. Commercial cartridges can be purchased at retail stores and used on the printing device 3 while the printing device 3 is in a normal mode in which no agreement has been entered into for the delivery service, or a previously entered agreement has been canceled and is no longer in effect. Contract cartridges are exclusive to the delivery service and cannot be purchased at retail stores. Contract cartridges can only be used on the printing device 3 for which an agreement has been entered into for the delivery service and is currently in effect. The cartridges used in the above delivery service are contract cartridges and hereinafter will be referred to as “contract cartridges 7.” In the present embodiment, the printing device 3 executes printing using contract cartridges 7 in the contract mode. On the other hand, since contract cartridges 7 cannot be used on the printing device 3 while the printing device 3 is in the normal mode, the printing device 3 executes printing using commercial cartridges in the normal mode.

The billing service includes, for example, a plurality of service plans. Under each service plan, users are charged a flat-rate fee for printing up to a predetermined number of printable pages within a service unit period (e.g., one month), and are charged an additional fee for printing that exceeds the predetermined number of printable pages within the service unit period. When the number of pages printed within a service unit period is less than the predetermined number of printable pages, the surplus is carried over to the next service unit period. In the delivery service according to the present embodiment, the billing service is initiated in response to contract cartridges 7 being loaded into (provided to) the printing device 3 at the start of the delivery service agreement.

The terminal device 2 in the present embodiment is a personal computer. The terminal device 2 includes a controller 11, a communication unit 12, a display 13, an input unit 14, and a storage 15. The controller 11 includes a CPU 21, and a memory 22. The CPU 21 controls the terminal device 2 by executing programs stored in the memory 22. The memory 22 includes semiconductor memory such as ROM, RAM, and flash memory. The communication unit 12 is a communication module for performing data communications with the management server 4 via the WAN 6. The display 13 is a liquid crystal display capable of displaying various information. The input unit 14 includes a keyboard and mouse and outputs detection signals to the controller 11 in response to input operations performed on the keyboard and mouse. The storage 15 includes a nonvolatile storage device such as an HDD and an SSD for storing various data. HDD is an abbreviation of “hard disk drive,” while SSD is an abbreviation of “solid-state drive.”

Four ink cartridges 71 through 74 (a first cartridge 71, a second cartridge 72, a third cartridge 73, and a fourth cartridge 74) are loaded into (provided to) the printing device 3. Here, the term “loaded into (provided to)” includes the meaning of a cartridge being loaded into (provided to) a cartridge holder. The printing device 3 is an inkjet printer that executes printing using the cartridges 71 through 74. The four cartridges 71 through 74 are also referred to simply as “cartridges 7” when no specific distinction is being made. The printing device 3 includes a controller 31, a communication unit 32, a display 33, an input unit 34, a printing mechanism 35, and a connector 36. The controller 31 includes a CPU 41, and a memory 42. The printing device 3 is an example of the “first consuming device” and the “consuming device” of the present disclosure. The controller 31 is an example of the “controller” of the present disclosure. The cartridge 7 is an example of the “consumable” of the present disclosure.

The CPU 41 controls the printing device 3 by executing programs stored in the memory 42. The memory 42 includes semiconductor memory such as ROM, RAM, and flash memory. The memory 42 stores a printing device program 23, a management program 24, and various data. The printing device program 23 is a computer program that instructs the CPU 41 to implement a print function. The management program 24 is a computer program that instructs the CPU 41 to implement functions for managing the delivery service.

The communication unit 32 is a communication module for performing data communications with the management server 4 via the WAN 6. The display 33 is a liquid crystal display capable of displaying various information. The input unit 34 includes a touchscreen arranged over the screen of the display 33, and switches arranged around the screen of the display 33. The input unit 34 outputs detection signals to the controller 11 in response to input operations that the user performs through the touchscreen and switches. The printing mechanism 35 includes a print head and can print images on a printing medium using colorants accommodated in the cartridges 71 through 74.

The connector 36 outputs to the controller 31 information read from memories respectively provided in the first cartridge 71, second cartridge 72, third cartridge 73, and fourth cartridge 74 removably loaded into (provided to) the printing device 3. The connector 36 also inputs into the memories respectively provided in the first cartridge 71, second cartridge 72, third cartridge 73, and fourth cartridge 74 information instructed to be written by the controller 31. The colorants in the present embodiment are inks. The first cartridge 71 has a first memory 75 and accommodates therein a cyan ink. The second cartridge 72 has a second memory 76 and accommodates therein a magenta ink. The third cartridge 73 has a third memory 77 and accommodates therein a yellow ink. The fourth cartridge 74 has a fourth memory 78 and accommodates therein a black ink.

The management server 4 manages the delivery of the cartridges 71 through 74 according to the terms of the agreement. In other words, the management server 4 performs delivery management of the cartridges 71 through 74 under the agreement. The management server 4 includes a controller 51, a storage 52, and a communication unit 53. The controller 51 includes a CPU 61, and a memory 62. The CPU 61 controls the management server 4 by executing programs stored in the memory 62. The management server 4 is an example of the “server” of the present disclosure. The controller 51 is an example of the “controller” of the present disclosure. The memory 62 includes semiconductor memory such as ROM, RAM, and flash memory. The memory 62 stores programs including a management program 63, and data. The management program 63 is a computer program that instructs the CPU 61 to implement functions for managing the delivery service.

In the present embodiment, the following description assumes that the printing device 3 executes the overall functions of managing the delivery service. However, the functions of managing the delivery service may alternatively be executed by the management server 4 or cooperatively executed by both the printing device 3 and management server 4. The storage 52 includes a nonvolatile storage device such as an HDD and an SSD for storing various data. The communication unit 53 is a communication module for performing data communications with the terminal device 2, printing device 3, and delivery server 5 via the WAN 6.

While not illustrated in the drawings, the delivery server 5 includes a controller, a communication unit, and a storage. The controller of the delivery server 5 receives a cartridge delivery instruction from the management server 4 when the management server 4 receives a cartridge delivery request from the printing device 3. In response to receiving the cartridge delivery instruction, the controller of the delivery server 5 performs a process to notify a delivery operator to deliver a contract cartridge 7 in accordance with the content of the cartridge delivery instruction. The delivery operator then delivers the contract cartridge 7 in accordance with the cartridge delivery instruction.

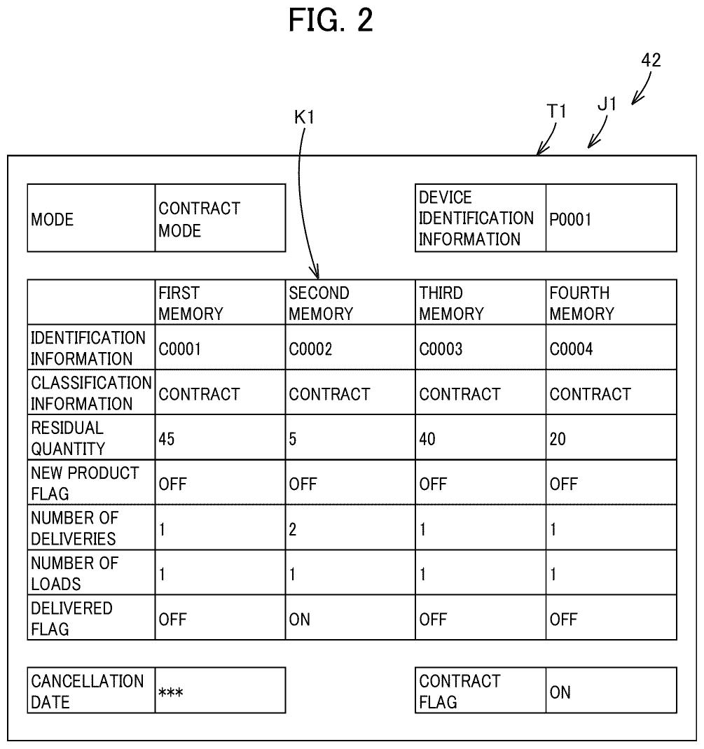

FIG. 2 illustrates a storage table T1 stored on the printing device 3. The storage table T1 is stored in the memory 42 of the printing device 3. The memory 42 stores therein various information including the mode of the printing device 3, device identification information of the printing device 3, cartridge information K1 on contract cartridges 7 loaded into (provided to) the printing device 3, a cancellation date, and a contract flag. FIG. 2 shows, as an example, a state J1 of the printing device 3 currently under agreement. In the state J1, all of the cartridges 71 through 74 loaded into (provided to) the printing device 3 are contract cartridges and the residual quantities of ink in the cartridges 71 through 74 have decreased as the cartridges 71 through 74 have been used for a certain period after being loaded into (provided to) the printing device 3.

As illustrated in FIG. 2, the printing device 3 stores information including the mode of the printing device 3, the device identification information of the printing device 3, the cartridge information K1 on contract cartridges 7 loaded into (provided to) the printing device 3, a cancellation date, and a contract flag in the storage table T1. In the present embodiment, the printing device 3 has two modes: a normal mode in which no agreement has been entered into for the delivery service described above or a previously entered agreement has been canceled and is no longer in effect; and a contract mode in which an agreement for the delivery service has been entered into and is currently in effect. The printing device 3 is in the contract mode during a service period under the delivery service agreement. The device identification information is a unique serial number that identifies the printing device 3.

The storage table T1 illustrated in FIG. 2 includes the cartridge identification information, classification information, residual quantity, new product flag, number of deliveries, number of loads, and delivered flag as the cartridge information K1 read from each of the first memory 75, second memory 76, third memory 77, and fourth memory 78. Each of the cartridge identification information, classification information, residual quantity, new product flag, number of deliveries, number of loads, and delivered flag is a value individually set for each of the contract cartridges 71 through 74 and is stored in the respective ones of the first memory 75, second memory 76, third memory 77, and fourth memory 78 in advance.

The cartridge identification information is a unique serial number for identifying one of the individual contract cartridges 71 through 74. The cartridge identification information may include information specifying the ink color, model number, manufacturer, and production lot of the contract cartridge 7. Although the cartridge identification information in the present embodiment incudes information identifying the expiration date, to simplify the description, the cartridge identification information is represented as a string of characters formed of an alphabetic letter and a four-digit number for convenience. For example, the cartridge identification information for the first cartridge 71 is “C0001.”

The classification information specifies the classification of cartridge (i.e., commercial or contract).

The residual quantity is information indicating the quantity of ink remaining in the contract cartridge 7. As one example, the residual quantity may be a value expressed as a percentage, where 100 represents the residual quantity of ink in an unused cartridge 7 (i.e., when the cartridge 7 is full). The residual quantity may also be the absolute quantity of ink. The residual quantity may be detected by a residual quantity sensor provided in the cartridge or may be calculated as the amount obtained by subtracting the consumed quantity of ink from the initial quantity of ink in the unused cartridge.

The new product flag is information indicating whether the printing device 3 has already started using the contract cartridge 7 or not, i.e., whether the contract cartridge 7 is used or unused. The new product flag has a value of “ON” when the contract cartridge 7 is unused and a value of “OFF” when the contract cartridge 7 is no longer unused but has been put into use. The new product flag is set to an initial value of “ON” and set to “OFF” when the contract cartridge 7 is loaded into (provided to) the printing device 3. In the example of FIG. 2, the new product flag is “OFF” for all cartridges 71 through 74 since all cartridges 71 through 74 are loaded into (provided to) the printing device 3 and in use.

The number of deliveries is information indicating the total number of contract cartridges 7 delivered during the service period under the agreement. Except under special circumstances, such as when a cancellation process is performed, a contract cartridge 7 is considered by the management system 1 to be already in the user's possession once the printing device 3 has transmitted a delivery request for the contract cartridge 7 to the management server 4. Thus, the number of deliveries in the present embodiment is incremented at the time the printing device 3 transmits a delivery request for a contract cartridge 7 to the management server 4. Details on how the number of deliveries is counted will be provided in the description of a process later.

The number of loads is information indicating the total number of times the corresponding cartridge among the cartridges 71 through 74 has been loaded into (provided to) the printing device 3 during the service period under the agreement. The cancellation date is information indicating the date on which the agreement is cancelled.

The delivered flag is information indicating whether the contract cartridge 7 has been delivered. The value of the flag is set to “ON” when the corresponding cartridge among the cartridges 71 through 74 has been delivered and “OFF” when the corresponding cartridge has not been delivered. The delivered flag is set to an initial value of “OFF”. The delivered flag is then switched to “ON” when the corresponding cartridge among the cartridges 71 through 74 has been delivered and is returned to “OFF” when the cartridge has been loaded into (provided to) the printing device 3. The term “delivery” refers to the entire course of a shipment (delivery process) beginning from the moment a delivery request for the cartridge 7 is issued and ending when the cartridge 7 reaches the user. The delivered flag is set to “ON” at the time a delivery request is transmitted for a contract cartridge 7, regardless of whether the contract cartridge 7 has already been shipped. The number of deliveries may be counted (incremented) at any point during the delivery process described above.

The cancellation date is used, for example, to calculate the time difference between the timing at which the user cancels the agreement and the timing at which the user enters into another (new) agreement for the delivery service. Here, the number of deliveries and number of loads are carried over from the previous agreement when the user enters into a new agreement.

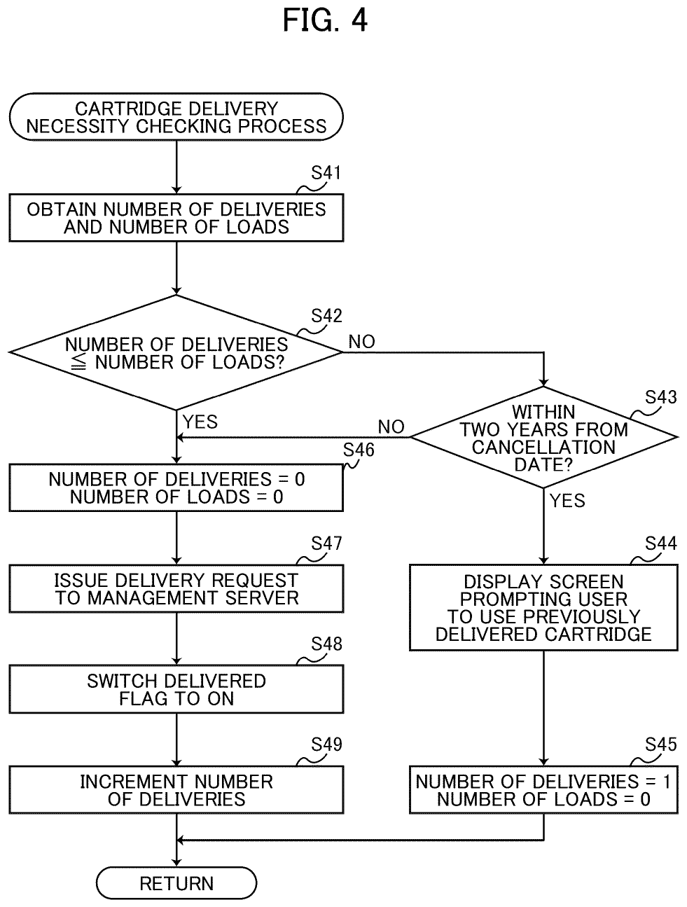

The contract flag is information indicating whether the printing device 3 is currently under an agreement for the delivery service described above, i.e., whether the printing device 3 is currently subject to delivery management under the agreement. The value of the contract flag is set to “ON” when the printing device 3 is under an agreement and “OFF” when the printing device 3 is not under an agreement. The contract flag is set to an initial value of “OFF”. After the user enters into an agreement for the printing device 3, the contract flag is set to “ON” following a cartridge delivery necessity checking process described later (see FIG. 4) and is reset to “OFF” when the agreement is canceled. After an initial agreement has been canceled, the contract flag is set in the same way described above when second and subsequent agreements are entered into and when such agreements are canceled. In other words, the contract flag is set to “ON” each time an agreement is entered into and “OFF” each time an agreement is canceled.

[Main Process]

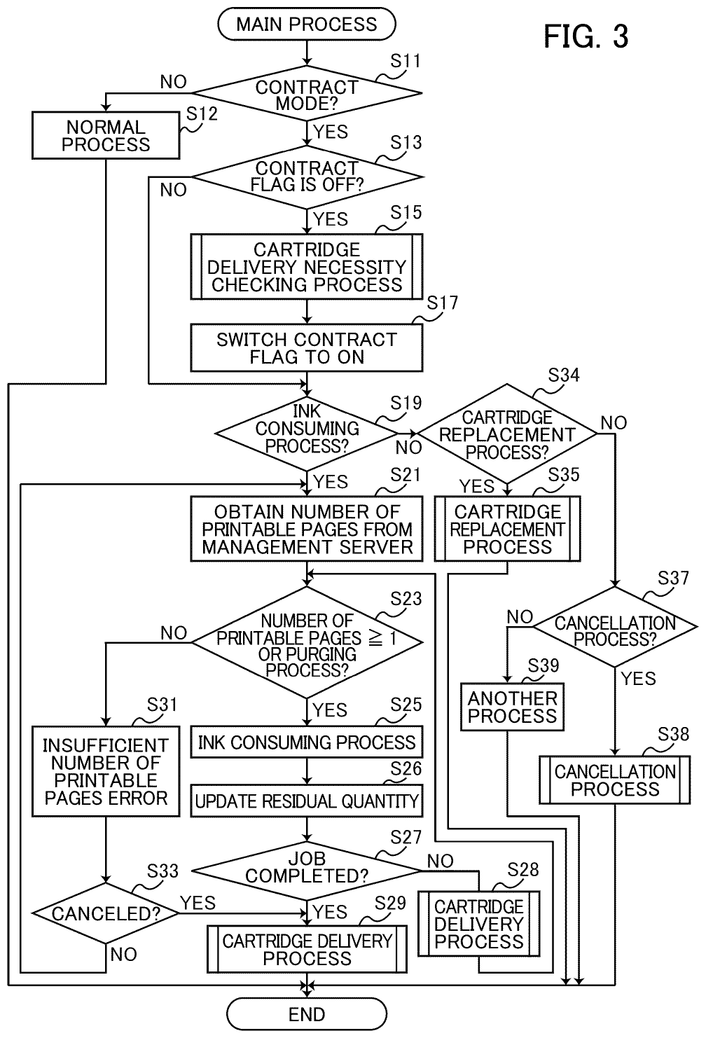

Next, a process executed on the printing device 3 will be described with reference to FIG. 3. FIG. 3 is a flowchart illustrating steps in a main process, including an ink consuming process, executed by the controller 31 of the printing device 3. The series of steps illustrated in FIG. 3 are repeatedly executed while the power to the printing device 3 is on. The process is initially triggered by the power to the printing device 3 being turned on. Each step in the following descriptions of processes will be denoted by “S” followed by the step number.

In S11 at the beginning of the process in FIG. 3, the controller 31 determines whether the printing device 3 is in the contract mode according to information on the mode stored in the storage table T1.

When the mode of the printing device 3 is the contract mode (S11: YES), in S13 the controller 31 determines whether the contract flag is “OFF”. When the contract flag is “OFF” (S13: YES), in S15 the controller 31 executes a process to check cartridge delivery necessity (cartridge delivery necessity checking process). The cartridge delivery necessity checking process will be described later in detail. When the printing device 3 is not in the contract mode but is in the normal mode (S11: NO), in S12 the controller 31 executes a normal process and subsequently ends the main process of FIG. 3. A normal process is a printing process or other process performed in the normal mode using commercial cartridges. After performing the cartridge delivery necessity checking process in S15, in S17 the controller 31 changes the contract flag from “OFF” to “ON”.

After switching the contract flag to “ON” or when the contract flag is not determined to be “OFF” in S13 (S13: NO), in S19 the controller 31 determines whether the process specified in a user instruction is an ink consuming process. Although not explicitly illustrated in the drawing, the controller 31 waits for a user instruction to be inputted and, upon receiving a user instruction, determines the process specified in the user instruction. While in the contract mode in the present embodiment, processes for which the user can issue instructions to the printing device 3 can be broadly classified as the following four processes: an ink consuming process (S25), a cartridge replacement process (S35), a cancellation process (S38), and another process (S39).

Examples of ink consuming processes are any processes in which ink is consumed, including a printing process such as printing or copying, and a purging process described later. When the specified process is an ink consuming process (S19: YES), in S21 the controller 31 obtains the number of printable pages from the management server 4 and in S23 determines whether the number of printable pages is at least one or whether the specified process is a purging process. When the number of printable pages is one or more or the specified process is a purging process (S23: YES), in S25 the controller 31 executes the ink consuming process.

A purging process is a nozzle cleaning process that consumes ink but is performed for maintenance. Thus, although an ink consuming process, the purging process can be performed regardless of the number of printable pages allowed by the billing service. Therefore, even when the number of printable pages is zero, when the specified ink consuming process is the purging process (S23: YES), the ink consuming process is allowed, and in S25 the controller 31 executes the ink consuming process. Similarly, when the number of printable pages is one or more (S23: YES), the ink consuming process can be executed, and in S25 the controller 31 executes the ink consuming process. After the process of S25, the controller 31 updates the residual quantity. The controller 31 may calculate the residual quantity by subtracting the quantity of ink consumed during the ink consuming process from the residual quantity prior to execution of the ink consuming process of S25. Alternatively, the controller 31 may detect the residual quantity after the ink consuming process of S25 using a residual quantity sensor provided in the cartridge 7. The controller 31 updates the residual quantity by overwriting the residual quantity stored in the storage table T1 with the obtained residual quantity.

In S27 the controller 31 then determines whether the entire job sequence for the ink consuming process of S25 has been completed. When the job is a process for printing a plurality of pages, for example, the controller 31 determines that the job has not been completed when there remain any unprinted pages and determines that the job has been completed when all pages have been printed. When the job has not been completed (S27: NO), in S28 the controller 31 executes a cartridge delivery process and subsequently returns to S23. The cartridge delivery process is performed to deliver a contract cartridge 7 on the condition that the residual quantity of ink in the contract cartridge 7 becomes less than a first threshold value. The cartridge delivery process will be described later in detail.

Note that the process of S28 may be omitted depending on the printing specifications. Once the job is completed (S27: YES), in S29 the controller 31 executes the cartridge delivery process, and subsequently ends the main process. The cartridge delivery process is executed after the job is completed to prepare for the next printing process or another ink consuming process since residual ink could have run out when printing the last page.

On the other hand, when the number of printable pages is less than one (i.e., not greater than or equal to one) and the specified process is not the purging process (S23: NO), in S31 the controller 31 displays an error message in the screen displayed on the display 33 (e.g., a liquid crystal display) of the printing device 3 indicating that the number of printable pages is insufficient. At the same time, the controller 31 may display a notification prompting the user to make a payment for the billing service. In S33 the controller 31 then determines whether the ink consuming process has been canceled. When the process has been canceled (S33: YES), in S29 the controller 31 executes the cartridge delivery process and subsequently ends the main process. However, when the ink consuming process has not been canceled (S33: NO), the controller 31 returns to S21.

When the specified process is not an ink consuming process (S19: NO), in S34 the controller 31 determines whether the specified process is a cartridge replacement process. The cartridge replacement process is performed when a cartridge 7 has run out of ink, for example, in order to remove the loaded cartridge 7 from the printing device 3 and load (provide) a new cartridge 7 into (to) its place. The cartridge replacement process will be described later in detail.

When the specified process is the cartridge replacement process (S34: YES), in S35 the controller 31 executes the cartridge replacement process and subsequently ends the main process.

When the specified process is not the cartridge replacement process (S34: NO), in S37 the controller 31 determines whether the specified process is a cancellation process. A cancellation process is performed when the user wishes to cancel the agreement. The cancellation process will be described later in detail. When the specified process is the cancellation process (S37: YES), in S38 the controller 31 executes the cancellation process and subsequently ends the main process.

However, when the specified process is not the cancellation process (S37: NO), in S39 the controller 31 executes another process and subsequently ends the main process. Examples of another process is a reading process with the scanner, a fax transmission process, and other processes that do not involve ink consumption.

In the first embodiment, each of the cartridges 71 through 74 is an example of the “consumable” of the present disclosure. The ink consuming process of S25 is an example of the “consuming process” of the present disclosure.

[Cartridge Delivery Necessity Checking Process]

Next, the cartridge delivery necessity checking process (S15 of FIG. 3) will be described with reference to FIG. 4. The cartridge delivery necessity checking process checks the need for shipping contract cartridges 7. In the cartridge delivery necessity checking process, the controller 31 determines whether any delivered and unused (unloaded) contract cartridges 7 remain in the possession of the user who has entered into the agreement. The controller 31 then prompts (encourages) the user to load and use any contract cartridges 7 that remain in the user's possession and arranges to deliver new contract cartridges 7 for those not in the user's possession. Since the controller 31 has determined in FIG. 3 that the mode of the printing device 3 is the contract mode and that the contract flag is “OFF” (S11: YES and S13: YES), the controller 31 performs the cartridge delivery necessity checking process the first time the main process is executed after the printing device 3 enters the contract mode.

When an agreement for the printing device 3 is entered into for the first time, or when another agreement for the printing device 3 is subsequently entered into again, the controller 31 changes the mode of the printing device 3 from the normal mode to the contract mode. When executing step S11 for the first time after entering the contract mode, the controller 31 determines whether any delivered and unused contract cartridges 7 remain available for the printing device 3 and executes the process to check cartridge delivery necessity according to these results. The cartridge delivery necessity checking process will be described next in detail.

FIG. 4 is a flowchart illustrating steps in the cartridge delivery necessity checking process. The cartridge delivery necessity checking process is executed for each of the cartridges 71 through 74 individually, i.e., for each type of consumable (e.g., each ink color).

In S41 at the beginning of the process in FIG. 4, the controller 31 obtains the number of deliveries and the number of loads for the target contract cartridge 7 stored in the memory 42. The process of S41 is an example of the “obtaining process” of the present disclosure.

In S42 the controller 31 determines whether the number of deliveries is less than or equal to the number of loads. When the number of deliveries is not less than or equal to the number of loads, i.e., is greater than the number of loads (S42: NO), in S43 the controller 31 determines whether the current date is within two years from the cancellation date of the previous (last) agreement. The process of S42 and S43 is an example of the “determination process” of the present disclosure.

The number of deliveries being greater than the number of loads (S42: NO) signifies that at least one contract cartridge 7 delivered under the previous agreement remains in the user's possession. As an example, when the agreement has been canceled while the storage table T1 is in the state J1 shown in FIG. 2, the number of deliveries of the second cartridge 72 is “2”, while the number of loads of the second cartridge 72 is “1”. Accordingly, since the number of deliveries is greater than the number of loads for the second cartridge 72, the controller 31 determines that a delivered contract cartridge 7 remains in the user's possession. Hence, when the current date is within two years from the cancellation date of the last agreement (S43: YES), the controller 31 can assume that not much time has passed since the shipment of the contract cartridge 7 under the last agreement. In this case, contract cartridges 7 delivered under the last agreement are considered for convenience to be within their usable period. In other words, since this signifies that a contract cartridge 7 delivered under the last agreement and not yet expired is in the user's possession, in S44 the controller 31 displays a screen on the display 33 (e.g., a liquid crystal display) of the printing device 3 prompting the user to use the previously delivered contract cartridge 7.

An example of “prompting the user to use” may be displaying a screen on the liquid crystal display of the display 33 with a message such as “Please load any unused cartridges that have been delivered to you.” to prompt the user to load these contract cartridges 7. Alternatively, the controller 31 may display the screen on the display 13 of the terminal device 2 rather than the display 33 of the printing device 3. The process of S44 is an example of the “notification process” of the present disclosure.

In addition to the above information, in the process of S44 the controller 31 in the present embodiment also provides, on the screen displayed on the display 13 of the printing device 3, guidance on how to proceed when there are no contract cartridges 7 in the user's possession. While the user is expected to possess a contract cartridge 7 based on the cartridge information K1 stored in the storage table T1 as described above, in some cases the user may not have any contract cartridges 7 due to some error or the user having lost the contract cartridges 7. Since contract cartridges 7 are to be redelivered in such cases, the controller 31 displays a message prompting the user to purchase the necessary contract cartridges 7 and provides contact information for making this purchase, such as a telephone number and email address.

The determination as to whether the current date is within two years from the cancellation date of the last agreement is made only in the case of second and subsequent agreements. That is, when the cancellation date is not stored in the storage table T1, the controller 31 makes no determination as to the cancellation date in S43 and advances to the process of S46.

Subsequently, in S45 the controller 31 corrects the number of deliveries to “1” and the number of loads to “0” and stores these values in the storage table T1 of the memory 42. Following step S45, the controller 31 ends the cartridge delivery necessity checking process. In the present embodiment, the number of deliveries is corrected to “1” and the number of loads is corrected to “0” in S45 because contract cartridges 7 are delivered one at a time for each type (each ink color) of cartridge 7. However, these values are appropriately modified when contract cartridges 7 are delivered two or more at a time for each type (each ink color), for example.

On the other hand, when the number of deliveries is less than or equal to the number of loads (S42: YES) or when two years has elapsed since the cancellation date (S43: NO), in S46 the controller 31 corrects the number of deliveries to “0” and the number of loads to “0” and stores these values in the storage table T1 of the memory 42. In S47 the controller 31 issues a delivery request requesting the management server 4 to deliver a contract cartridge 7 to the user. The process of S47 is an example of the “delivery requesting process” of the present disclosure. The process in S42, S46, and S47 constitutes a delivery requesting process that the controller 31 performs when unused contract cartridges 7 that have been delivered are not present.

Here, the controller 31 requests delivery of a contract cartridge 7 in S47 when the number of deliveries is less than or equal to the number of loads (S42: YES) because this signifies that the user has no more contract cartridges 7 that have been delivered under the previous agreement. Hence, new contract cartridges 7 are to be delivered. Further, even when contract cartridges 7 delivered under the previous agreement remain in the user's possession, the ink has likely passed its expiration date when two years has passed since the cancellation date (S43: NO). Therefore, new contract cartridges 7 are also to be delivered in this case. In the present embodiment, the “cancellation date” is used as a value related to the usable period of the contract cartridge 7, and the usable period is set to two years from this cancellation date for convenience, but this value can be adjusted as appropriate.

After issuing a delivery request to the management server 4 in S47, in S48 the controller 31 changes the delivered flag from “OFF” to “ON”. In S49 the controller 31 increments the number of deliveries by one and then ends the cartridge delivery necessity checking process. The number of deliveries incremented in S49 is stored in the storage table T1 of the memory 42. Following the process of S47, the delivery server 5 performs a process for notifying the delivery operator to deliver contract cartridges 7 in accordance with the content of the cartridge delivery instructions from the management server 4.

### [Cartridge Delivery Process]

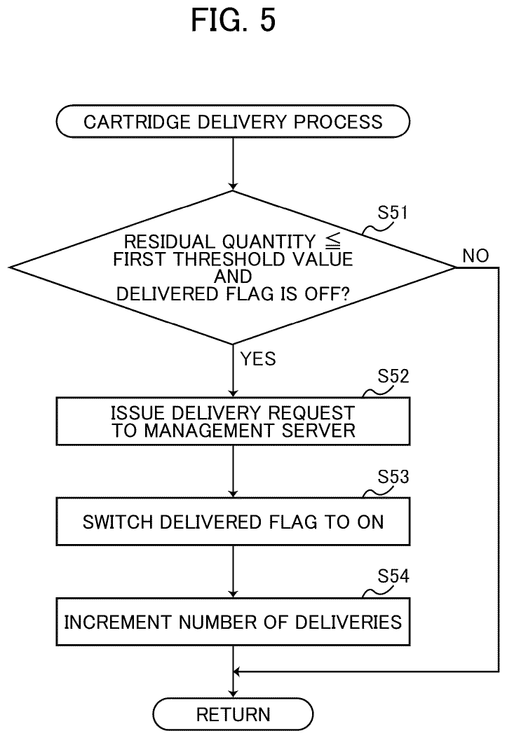

Next, the cartridge delivery process of S28 and S29 in FIG. 3 will be described with reference to FIG. 5. FIG. 5 is a flowchart illustrating steps in the cartridge delivery process. The cartridge delivery process is executed for each of the cartridges 71 through 74 individually.

As illustrated in FIG. 5, in S51 the controller 31 determines whether the residual quantity of ink in the contract cartridge 7 is less than or equal to a first threshold value and the delivered flag is “OFF”.

To make the determination in S51, the controller 31 reads and obtains the residual quantity and the value of the delivered flag for the target contract cartridge 7 from the storage table T1 of the memory 42. The first threshold value is set to a predetermined value at which the residual quantity of ink is low but before the ink is completely used up. For example, the residual quantity is set between 5 and 10, with 100 representing the residual quantity of ink in an unused cartridge. Alternatively, the consumed quantity may be used in place of the residual quantity. Furthermore, the printing device 3 may transmit information on the residual quantity or consumed quantity to the management server 4, and the controller 51 of the management server 4 may execute the determination of S51.

When the residual quantity of ink in the target contract cartridge 7 is less than or equal to the first threshold value and the delivered flag is “OFF” (S51: YES), in S52 the controller 31 issues a delivery request requesting the management server 4 to deliver a new contract cartridge 7 of the same type (same ink color) as the target contract cartridge 7. The process of S52 is an example of the “delivery requesting process” of the present disclosure.

In S53 the controller 31 changes the delivered flag from “OFF” to “ON”. In S54 the controller 31 increments the number of deliveries by one and subsequently ends the cartridge delivery process. The number of deliveries incremented in S54 is stored in the memory 42. That is, the numerical value for the number of deliveries is overwritten in the cartridge information K1 shown in FIG. 2. The process of S54 is an example of the “delivery information storing process” of the present disclosure.

When the residual quantity of ink in the contract cartridge 7 is greater than the first threshold value or the delivered flag is “ON” (S51: NO), the controller 31 ends the cartridge delivery process. When the residual quantity of ink in the contract cartridge 7 is greater than the first threshold value, delivery of a new contract cartridge 7 is unnecessary since the contract cartridge 7 still contains sufficient ink. Furthermore, when the delivered flag is “ON”, delivery of a new contract cartridge 7 is unnecessary since the procedure for delivering a contract cartridge 7 has already been started.

### [Cartridge Replacement Process]

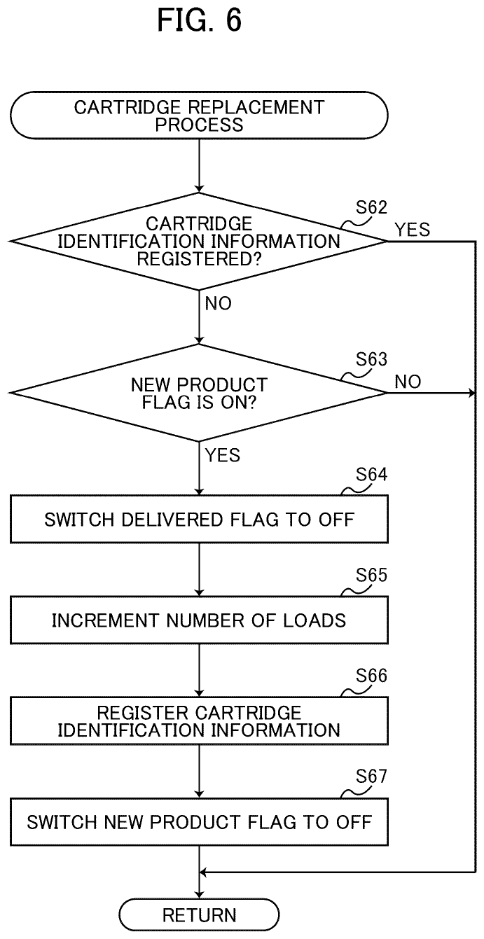

Next, the cartridge replacement process of S35 in FIG. 3 will be described with reference to FIG. 6. FIG. 6 is a flowchart illustrating steps in the cartridge replacement process. When two or more contract cartridges 7 are replaced, the controller 31 executes the cartridge replacement process for each of the replacement contract cartridges 7. Here, the replacement contract cartridge 7 indicates a contract cartridge 7 which has been newly loaded into (provided to) the printing device 3.

In S62 of FIG. 6, the controller 31 determines whether cartridge identification information of the replacement contract cartridge 7 has been registered on the printing device 3. For the determination of S62, the controller 31 obtains four sets of cartridge identification information stored in the storage table T1 illustrated in FIG. 2 and compares cartridge identification information of the newly loaded (provided) cartridge 7 with each of the obtained sets of cartridge identification information. The comparison of the cartridge identification information of the replacement contract cartridge 7 may be made only with the cartridge identification information stored in the storage table T1 for the same type (same ink color) of the cartridge with the replacement contract cartridge 7.

When the cartridge identification information of the newly loaded (provided) cartridge 7 does not match any of the obtained sets of cartridge identification information, the controller 31 determines that the cartridge identification information of the newly loaded (provided) cartridge 7, i.e., the cartridge identification information of the replacement contract cartridge 7 has not been registered (S62: NO). When the cartridge identification information of the replacement contract cartridge 7 has not been registered, the controller 31 can determine that this cartridge 7 is a new cartridge or a used cartridge that has been used by another user. When the identification information of the replacement contract cartridge 7 has been registered, on the other hand, the controller 31 determines that the replacement contract cartridge 7 has been obtained by the user himself or herself and has already been used.

When the identification information of the replacement contract cartridge 7 has not been registered on the printing device 3 (S62: NO), in S63 the controller 31 determines whether the new product flag is “ON”. When the new product flag is “ON” (S63: YES), the replacement contract cartridge 7 is a new product and not a used product that has been used by another person. Therefore, in S64 the controller 31 changes the delivered flag from “ON” to “OFF”. Since the delivered flag is set to “ON” either in S48 of the cartridge delivery necessity checking process of FIG. 4 or in S53 of the cartridge delivery process in FIG. 5, the controller 31 resets this delivered flag to “OFF” in the process of S64 upon the load (provision) of the contract cartridge 7 into (to) the printing device 3. As a result, delivery of the contract cartridge 7 becomes possible again when needed.

In S65 the controller 31 increments the number of loads by one. In S66 the controller 31 stores cartridge identification information of the replacement contract cartridge 7 in the memory 42. Subsequently, in S67 the controller 31 changes the new product flag from “ON” to “OFF”, and ends the cartridge replacement process. The number of loads incremented in S65 is stored in the memory 42. That is, a numerical value for the number of loads is overwritten in the cartridge information K1 stored in the storage table T1 illustrated in FIG. 2. However, when cartridge identification information of the replacement contract cartridge 7 has been registered on the printing device 3 (S62: YES), or when the new product flag is “OFF” (S63: NO), the controller 31 ends the cartridge replacement process in all cases. The process to increment the number of loads in S65 described above is an example of the “provision information storing process” of the present disclosure.

Note that while the controller 31 executes the process described above in S62 and S63 to determine whether the replacement contract cartridge 7 is a new product rather than a used product, the controller 31 may just execute the process of S63 instead. Furthermore, when the setting for a new product flag is specific to contract cartridges, the controller 31 can determine that the replaced cartridge 7 is a new contract cartridge simply by finding the existence of a new product flag in the process of S63.

### [Cancellation Process]

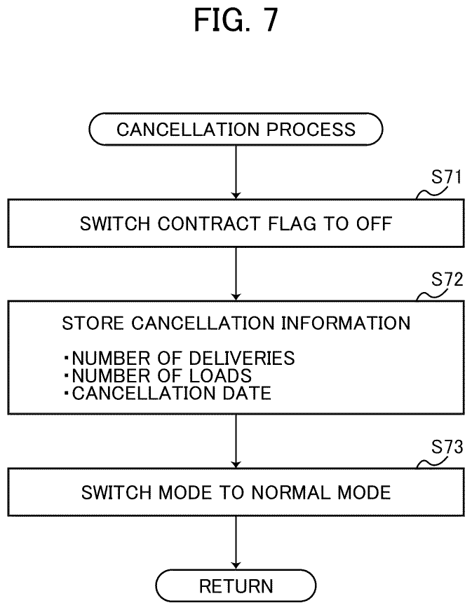

Next, the cancellation process of S38 in FIG. 3 will be described with reference to FIG. 7. FIG. 7 is a flowchart illustrating steps in the cancellation process. This cancellation process is performed when a user who has entered into an agreement for the delivery service issues a request to cancel the agreement.

As illustrated in FIG. 7, in S71 the controller 31 changes the contract flag from “ON” to “OFF” and in S72 stores cancellation information in the memory 42. The cancellation information is used to carry over information from the previous agreement in the event that the user enters into a new agreement for the delivery service. The cancellation information includes the number of deliveries and number of loads for each contract cartridge 7, and the cancellation date. By storing the cancellation information at the time of cancellation, the controller 31 can obtain and use the cancellation information when the user enters into a new agreement again.

In S73 the controller 31 changes the mode of the printing device 3 from the contract mode to the normal mode and subsequently ends the cancellation process. More specifically, in the process of S73 the controller 31 overwrites the mode stored in the storage table T1 with “normal mode” and issues a cancellation notification to notify the management server 4 of the cancellation. Upon receiving the cancellation notification, the management server 4 stores information indicating that the agreement has been canceled in the storage 52 in association with information on the printing device 3 stored in the storage 52.

Consider a case in which the user of the delivery service provided by the management system 1 described above cancels the agreement for the delivery service and does not enter into another agreement while the printing device 3 is in the state J1 shown in FIG. 2 but then enters into a new agreement for the delivery service within two years of the cancellation date. In this case, the cancellation date will have been stored in the location of the storage table T1 provided for the cancellation date. Using the example of FIG. 2, the number of deliveries for the second cartridge 72 is “2” and the number of loads for the second cartridge 72 is “1” at the time of the cancellation of the last agreement. Therefore, when the user begins using the printing device 3 after entering into a new agreement for the delivery service, the controller 31 of the printing device 3 determines that the user still possesses one unused second cartridge 72 and in S44 notifies the user of this fact. That is, the controller 31 displays a screen prompting the user to use the second cartridge 72 once the user begins using the printing device 3 after entering into a new agreement. In this way, the controller 31 can prompt the user to load (provide) and use any unused contract cartridges 7.

The management system 1 according to the first embodiment, having the configuration described above, has the following operations and effects:

(1) In the management system 1 according to the first embodiment described above, the controller 31 of the printing device 3 executes a process to store the number of loads in S65 (provision information storing process), a process to issue a delivery request for a new contract cartridge in S47 and S52 (delivery requesting process), a process to store the number of deliveries in S54 (delivery information storing process), a process to obtain the number of loads and number of deliveries in S41 (obtaining process), a process to determine whether an unused contract cartridge exists in S42 and S43 (determination processes), and a process to output a notification prompting use of the unused contract cartridge in S44 (notification process). Through the notification process, the printing device 3 can effectively utilize unused contract cartridges 7 by prompting the user to use of delivered but unused contract cartridges 7. To execute this notification, the management system 1 manages just the number of deliveries and number of loads of contract cartridges 7 without performing complex management of identification information for the contract cartridges 7, thereby reducing the amount of memory used for such management.

(2) In the management system 1 according to the first embodiment described above, the controller 31 of the printing device 3 determines in the determination process (S42) whether the number of deliveries is greater than the number of loads. The controller 31 executes the notification process (S44) when determining that the number of deliveries of the contract cartridge 7 is greater than the number of loads of the contract cartridge 7. By using the “number of loads” as provision information indicating the provision status of consumables to the printing device 3 and the “number of deliveries” as delivery information in this way, the controller 31 can easily determine whether any delivered but unused contract cartridges 7 are in the user's possession.

(3) In the management system 1 according to the first embodiment described above, the controller 31 of the printing device 3 executes the notification process (S44) when the user of the printing device 3 has entered into a new agreement (S13, S15) after the previous agreement has been canceled. Therefore, the printing device 3 can effectively utilize contract cartridges 7 delivered under the previous agreement when the user enters into another agreement.

(4) In the management system 1 according to the first embodiment described above, the controller 31 of the printing device 3 uses the cancellation date for the delivered but unused contract cartridge 7 to determine in the determination process (S43) whether the delivered but unused contract cartridge 7 is still within its usable period. The controller 31 executes the notification process (S44) when a delivered but unused contract cartridge 7 exists and the controller 31 determines in the determination process that the cartridge 7 is within the usable period. Therefore, the printing device 3 can be configured to prompt the user to use of unexpired contract cartridges 7 but not the use of expired contract cartridges 7.

(5) In the management system 1 of the first embodiment described above, the controller 31 of the printing device 3 executes the provision information storing process (S65), the delivery requesting process (S47, S52), the delivery information storing process (S54), the obtaining process (S41), the determination process (S42, S43), and the notification process (S44) for each of the four types of cartridges 71 through 74. In the notification process (S44), the controller 31 prompts the user to use of contract cartridges 7 that have been determined in the determination processes (S42, S43) to be delivered but unused. Accordingly, a printing device 3 into which a plurality of types of consumables can be loaded (to which a plurality of types of consumables can be provided) can issue (output) individual notifications for the plurality of types of consumables that can be effectively utilized.

(6) In the management system 1 of the first embodiment described above, the controller 31 of the printing device 3 executes the delivery requesting process (S47) when determining in the determination processes (S42, S43) that the user does not possess any delivered but unused contract cartridges 7. Therefore, the management system 1 can quickly deliver contract cartridges 7 to the user when the user possesses no delivered but unused contract cartridges 7.

(7) In the management system 1 of the first embodiment described above, the controller 31 of the printing device 3 provides a guidance in the notification process (S44) on how to proceed when the user possesses no delivered but unused contract cartridges 7. Specifically, the controller 31 displays a screen with a message prompting the user to purchase a contract cartridge 7 and notifying the user of the telephone number and email address for making that purchase. This improves user convenience by enabling the user to quickly purchase contract cartridges 7 according to the guidance when the user possesses no unused contract cartridges 7.

### Second Embodiment

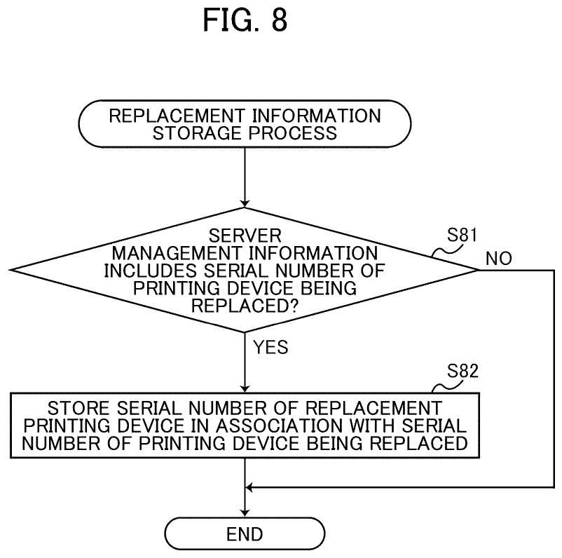

Next, a management system according to a second embodiment of the present disclosure will be described with reference to FIGS. 8 through 10, wherein configurations essentially the same as those in the first embodiment are designated with the same reference numerals to avoid duplicating description. The management system according to the second embodiment includes a first printing device and a second printing device different from the first printing device. The configurations of the first printing device and second printing device are identical to those of the printing device 3 described in the first embodiment, but each has different device identification information. For convenience, the first printing device will be called the “first printing device 301” in the following description and the second printing device will be called the “second printing device 302” in the following description. The first printing device 301 is an example of the “first consuming device” of the present disclosure. The second printing device 302 is an example of the “second consuming device” of the present disclosure.

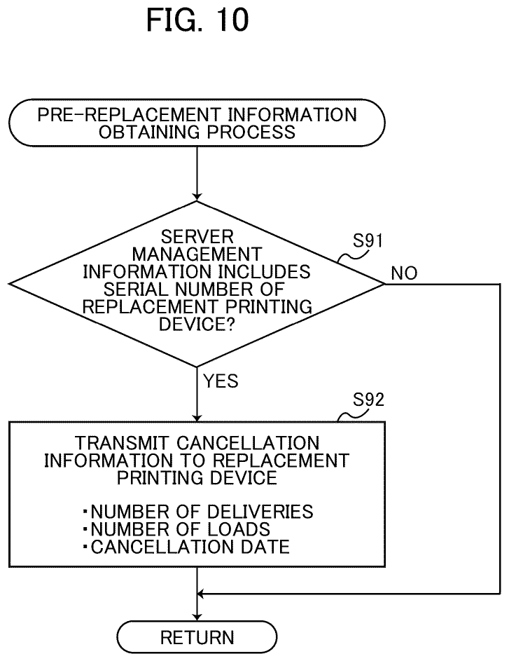

When the first printing device 301 is replaced with the second printing device 302 while the first printing device 301 is under agreement, the management system of the second embodiment performs a process to transfer various information from the first printing device 301, including the number of loads and number of deliveries for each contract cartridge 7 and the cancellation date, to the second printing device 302. That is, the management system of the second embodiment executes a replacement information storage process (FIG. 8) and a pre-replacement information obtaining process (FIG. 10). The replacement information storage process and pre-replacement information obtaining process will be described in detail below.

FIG. 8 is a flowchart illustrating steps in the replacement information storage process for printing devices 3. The replacement information storage process is executed by the management server 4. The administrator initiates the replacement information storage process illustrated in FIG. 8 by performing a registration starting operation to register information related to a new replacement printing device 3 (the second printing device 302) on the management server 4. In FIGS. 8 through 10 and in the following description, the device identification information is also expressed as the “machine serial number” or simply the “serial number”.

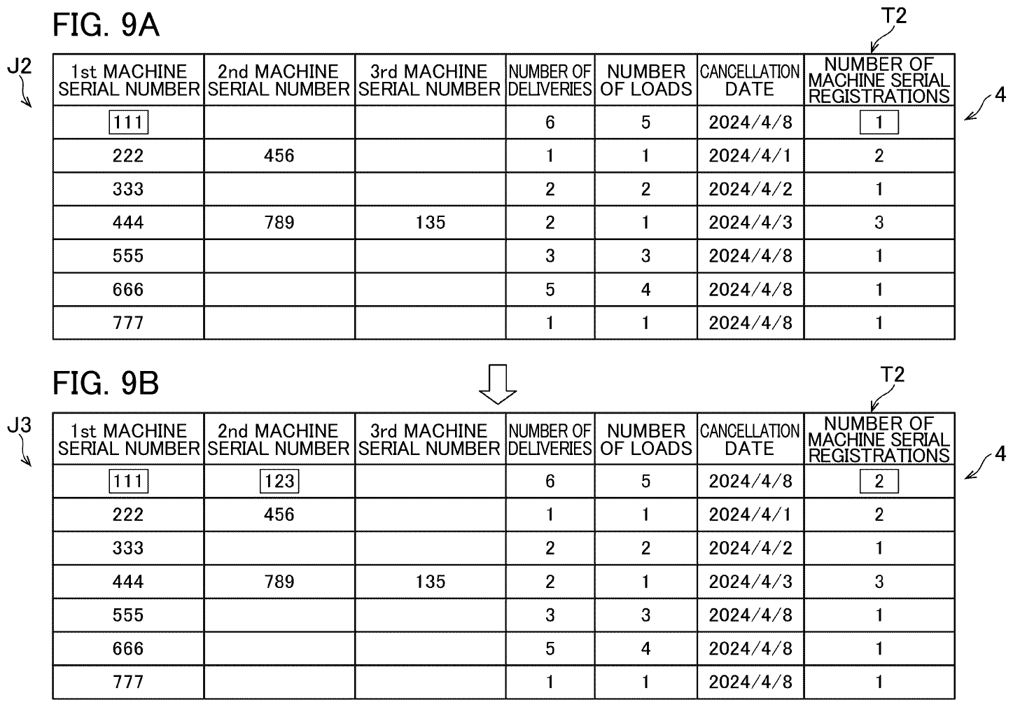

FIGS. 9A and 9B illustrate a storage table T2 stored in the storage 52 of the management server 4. The storage table T2 stores therein management information (hereinafter also referred to as “server management information”). The serial number of the first printing device 301 is “111” and the serial number of the second printing device 302 is “123”. As illustrated in FIG. 9, the premise of the management system according to the second embodiment is that the management server 4, rather than the first printing device 301, manages the machine serial numbers, the number of deliveries, the number of loads, the cancellation date, and the number of machine serial registrations associated with the agreement for which the first printing device 301 is the subject. That is, information including the machine serial numbers, the number of deliveries, the number of loads, the cancellation date, and the number of machine serial registrations is stored in the storage 52 of the management server 4 as server management information corresponding to each user who has entered into an agreement regarding the delivery service for a corresponding printing device 3 (e.g., the first printing device 301). The number of machine serial registrations included in the server management information corresponding to a user indicates the number of times that the printing device 3, which is the subject of the agreements, has been replaced with another printing device 3 during the service periods under the agreements entered into by the user, due to a malfunction, for example.

FIGS. 9A and 9B illustrate a case of transitioning from a state J2 (shown in FIG. 9A) in which the number of machine serial registrations is “1” for the first printing device 301 (machine serial number “111”) to a state J3 (shown in FIG. 9B) in which the first printing device 301 has been replaced with the second printing device 302 (machine serial number “123”) and the number of machine serial registrations has been incremented to “2”. In this example, the server management information stored in the storage table T2 in the storage 52 for state J2 illustrated in FIG. 9A is changed to the server management information for state J3 illustrated in FIG. 9B. The storage table T2 has storage locations for storing three machine serial numbers (a first machine serial number, a second machine serial number, and a third machine serial number) and for storing the number of deliveries, number of loads, cancellation date, and number of machine serial registrations in a record for each user who has entered into an agreement.

As illustrated in FIG. 8, in S81 the controller 51 of the management server 4 determines whether the server management information managed by the management server 4 includes a machine serial number of the printing device 3 which is being replaced and the source of the transfer. Specifically, when the serial number of the first printing device 301 (“111” in the example of FIGS. 9A and 9B), which is being replaced and the source of the transfer, is inputted by the administrator of the management server 4, the controller 51 searches the storage table T2 stored in the storage 52 to determine whether the corresponding serial number exists in the storage table T2.

When the serial number of the printing device 3 being replaced exists in the storage table T2 (S81: YES), in S82 the controller 51 stores a machine serial number of the replacement printing device 3, which is the recipient of the transfer, in association with the machine serial number of the printing device 3 being replaced, which is the source of the transfer, as identified in S81.

As a specific example, the administrator of the management server 4 inputs the serial number of the second printing device 302 (“123” in the example of FIGS. 9A and 9B), which is the replacement printing device 3 of the first printing device 301 and the recipient of the transfer in the above process. The controller 51 refers to the storage table T2 to store the inputted serial number of the second printing device 302 in association with the serial number of the first printing device 301 identified in S81. In the example of FIG. 9A, the controller 51 stores the serial number of the second printing device 302 (“123”) in the storage location for the second machine serial number corresponding to the first printing device 301, as shown in the storage table T2 illustrated in FIG. 9B. Next, the controller 51 updates the number of machine serial registrations associated with the serial number of the first printing device 301 identified in S81 to “2”. In other words, the controller 51 increments the corresponding number of machine serial registrations by one. Thus, these processes serve to link the number of deliveries, number of loads, and cancellation date from the first printing device 301 being replaced to the replacement second printing device 302. In other words, the machine serial number of the replacement second printing device 302 is associated with the server management information including the number of deliveries, number of loads, and cancellation date from the first printing device 301 being replaced. The controller 51 subsequently ends the replacement information storage process.

Note that since up to three machine serial numbers can be registered in the storage table T2 in the second embodiment, serial numbers are sequentially overwritten beginning from the first machine serial number when replacing the printing device 3 a third or successive time. For example, the new serial number is stored under the second machine serial number when the number of machine serial registrations is “1” and under the first machine serial number when the number of machine serial registrations is “3”. When the controller 51 does not find a corresponding serial number in S81 (S81: NO), on the other hand, the controller 51 ends the replacement information storage process.

FIG. 10 is a flowchart illustrating steps in a pre-replacement information obtaining process. The pre-replacement information obtaining process is executed by the management server 4 when the printing device 3 is being replaced. The controller 51 of the management server 4 executes the process in FIG. 10 after the printing device 3 initiates the cartridge delivery necessity checking process in S15 of FIG. 3 and before the printing device 3 executes the process to obtain the number of deliveries and number of loads in S41 of FIG. 4.

As illustrated in FIG. 10, in S91 the controller 51 of the management server 4 determines whether the server management information managed by the management server 4 includes a machine serial number of the replacement printing device 3. Specifically, when the printing device 3 (the first printing device 301) is being replaced with the second printing device 302, the second printing device 302 transmits the machine serial number (“123”) of the second printing device 302 to the management server 4. The information transmitted at this time corresponds to “replacement information indicating that the first printing device 301 has been replaced with the second printing device 302.” In the process of S91 the controller 51 then searches the storage table T2 stored in the storage 52 to determine whether the corresponding machine serial number (“123”) exists in the storage table T2.

When the serial number of the replacement printing device 3, i.e., the second printing device 302 exists in the storage table T2 (S91: YES), in S92 the controller 51 transmits cancellation information to the second printing device 302. As described above, the cancellation information includes the number of deliveries and number of loads of each of the contract cartridges 7 and the cancellation date. In other words, in the process of S41 illustrated in FIG. 4 the second printing device 302 obtains the number of deliveries and number of loads of each of the contract cartridges 7 for the first printing device 301 and inherits the obtained information. The second printing device 302 executes the process of S42 (determination process) and the process of S44 (notification process) using the number of deliveries and number of loads for the first printing device 301. On the other hand, when the machine serial number of the replacement printing device 3, i.e., the second printing device 302 does not exist in the storage table T2 (S91: NO), the controller 51 ends the pre-replacement information obtaining process without transmitting any cancellation information.

When the first printing device 301 currently under agreement is replaced with the second printing device 302 in the management system according to the second embodiment described above, the management server 4 executes the replacement information storage process (FIG. 8) and the pre-replacement information obtaining process (FIG. 10). As a result, various information from the first printing device 301, including the number of loads and number of deliveries of each of the contract cartridges 7 and the cancellation date, can be transferred to the second printing device 302. Therefore, contract cartridges 7 that have been delivered to the first printing device 301 prior to this replacement can be effectively utilized in the replacement second printing device 302.

### Other Embodiments

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

In the management system 1 of the embodiments described above, ink cartridges 7 are described as an example of the consumables, but the consumables may be any component that is replaceable in a consuming device, such as an inkjet head, a toner cartridge or process cartridge (when the printing device 3 is a laser printer), a waste liquid tank, and conveying rollers. When the consumables are toner cartridges or process cartridges, the timing for delivery can be set by determining the service life of each consumable based on the residual quantity of toner in the corresponding consumable, for example. When the consumables are inkjet heads or waste liquid tanks, the timing for delivery can be set by determining the service life of each consumable based on the quantity of ink ejected from the inkjet head, the number of ink ejections, for example. When the consumables are conveying rollers, the timing for delivery can be set by determining the service life of each consumable based on the number of revolutions of the rollers, for example. With printers that do not have cartridge holders into which cartridges 7 are loaded (to which cartridges 7 are provided) but possess ink tanks into which ink is injected (to which ink is provided), the consumable may be ink. Thus, the items that are delivered are bottles of ink, while the consumable is the ink itself.

In addition to the cartridges 71 through 74 in the embodiments, the aforementioned inkjet heads, conveying rollers, and other components may be combined as the plurality of types of consumables, and the management system 1 may be configured to perform the delivery process for each type of consumable.

In the management system 1 of the above embodiments, “number of loads” is used as the claimed provision information and “number of deliveries” as the claimed delivery information, and a comparison of these numbers is used to determine whether the user possesses consumables that have been delivered but not loaded (provided). As an alternative, “loaded (provided) consumable IDs” may be used as the provision information, while “delivered consumable IDs” may be used as the delivery information. In this case, the delivered consumable IDs and loaded (provided) consumable IDs can be managed and used to determine that the user possesses any delivered but unused consumables when the user possesses a consumable whose delivered consumable ID is stored but whose loaded (provided) consumable ID is not.

Furthermore, “information on whether the consumable has been delivered” may be used as the delivery information, and the “number of times the consumable has been replaced (the number of reloads)” may be used as the provision information. When, while managing the information on whether consumables have been delivered and managing the number of times the consumables have been replaced, the controller 31 determines that the number of times a consumable has been replaced has not increased after the delivery of the consumable, i.e., after information indicating that the consumable has been delivered is obtained, the controller 31 can determine that the user possesses a consumable that has been delivered but not yet used.

Furthermore, “information on whether consumables have been delivered” may be used as the delivery information, while “the residual quantities of consumables loaded into (provided to) the consuming device” may be used as the provision information. When, while managing the information on whether consumables have been delivered and the residual quantities of consumables loaded into (provided to) the consuming device, the controller 31 determines that the residual quantity of a consumable has not increased after the delivery of the consumable, i.e., after information on the consumable being delivered has been obtained, the controller 31 can determine that the consumable has been delivered and is unused. For example, this can be applied to the case in which the consumable is ink itself, as described above.

In the management system 1 of the above embodiments, the number of deliveries is incremented in S49 and S54. The number of deliveries is incremented in S49 and S54 regardless of whether the contract cartridge 7 has actually been shipped since, unless any special circumstances arise, the contract cartridges 7 are always delivered when an instruction is issued to deliver the contract cartridge 7 (S47, S52), i.e., when the delivery requesting process is performed. However, in order to manage the number of deliveries of contract cartridges 7 more accurately, the number of deliveries may be incremented when the delivery server 5 notifies the delivery operator to deliver the contract cartridges 7 after the delivery server 5 has received the cartridge delivery instructions, for example.

Furthermore, the number of deliveries may be incremented when the management server 4 receives information from the delivery server 5 indicating that the contract cartridge 7 has actually been shipped. Additionally, the management server 4 may be configured to perform a process to cancel an increment in the number of deliveries when an error occurs during delivery. Any of these cases is possible, provided that the number of deliveries can be counted as delivery information indicating the delivery status of the contract cartridge 7.

The second embodiment describes a case in which the first printing device 301 in the management system is replaced with the second printing device 302 while the first printing device 301 is under agreement. However, the present disclosure may similarly be applied to a case in which the agreement for the first printing device 301 is canceled while the first printing device 301 is still in use and the same user subsequently re-enters into an agreement while at the same time replacing the first printing device 301 with a new second printing device 302.

In the management system 1 of the above embodiments, the cancellation date is used as the “value related to the usable period” and the controller 31 determines whether the contract cartridge 7 is within its usable period based on whether the current date is within two years from the cancellation date. However, an expiration date itself may be used as the “value related to the usable period” to determine whether the contract cartridge 7 is within this usable period, i.e., the contract cartridge 7 has not passed the expiration date. Additionally, the agreement executed date, the delivery date, or the manufacturing date may be used as the “value related to the usable period” and an elapsed period from this date may be used to determine as to the usable period.

While the obtaining process (S41), the determination process (S42), and the notification process (S44) are executed in the management system 1 of the above embodiments when the user enters into another agreement for the delivery service, these processes may always be executed while the user is under agreement. The determination process (S42) may also be executed when the agreement is canceled, and the notification process (S44) may be executed when the user enters into another agreement.

The configuration of the management system 1 in the above embodiments may be changed as appropriate. For example, the management server 4 may include a plurality of physical servers. Alternatively, the management server 4 may include at least one of a plurality of virtual servers constructed by dividing one physical server using virtualization software. Further, the delivery server 5 may be eliminated from the management system 1 described above and the management server 4 may be responsible for the process of notifying the delivery company. As described in the second embodiment, the management system 1 may include a plurality of printing devices 3, even three or more.

The printing device 3 in the management system 1 of the above embodiments may be a multifunction peripheral, copier, or facsimile machine with a scanning function for reading images from documents. The printing device 3 may be a laser printer or an LED printer, for example. An LED printer uses an LED head as means for exposing a photosensitive member. In this case, the colorant is toner. The number, type, and number of types of cartridges 7 loaded into (provided to) the printing device 3 and the colorants they possess may be changed as appropriate.

While the controller 31 of the printing device 3 executes the overall processing functions illustrated in FIGS. 4, 5, and 7 to manage the delivery service in the management system 1 of the above embodiments, these processing functions may be implemented by the controller 51 of the management server 4 instead. In this case, information similar to the storage table T1 illustrated in FIG. 2 may be stored in the storage 52 of the management server 4. Further, the process executed in S47 and S52 to issue a request to the management server 4 for the delivery of consumables may be replaced by a process for requesting the delivery server 5 for the delivery of consumables.

While the invention has been described in detail with reference to specific embodiments thereof, it would be apparent to those skilled in the art that many modifications and variations may be made therein without departing from the spirit of the invention, the scope of which is defined by the attached claims. For example, the technical features in each embodiment that corresponds to technical features of aspects described in the Summary of the Invention may be replaced or combined as needed to solve some or all of the problems described above or to realize some or all of the above effects. Moreover, any technical feature not described as essential to this specification may be eliminated as appropriate.

The present disclosure may be achieved in various forms, including a computer-readable non-transitory medium such as semiconductor memory storing the management program 63, a management method, and a computer-readable non-transitory medium such as semiconductor memory storing the printing device program 23. The management method can be realized through a method including a consuming process executed by the printing device 3 as the consuming device; and a provision information storing process, a delivery requesting process, a delivery information storing process, an obtaining process, a determination process, and a notification process executed by at least one of the printing device 3 and management server 4.

Note that the present disclosure includes the phrases “at least one of A and B”, “at least one of A, B and C”, and the like as alternative expressions that mean one or more of A and B, one or more of A, B and C, and the like, respectively. More specifically, the phrase “at least one of A and B” means (A), (B) or (A and B), and the phrase “at least one of A, B and C” means (A), (B), (C), (A and B), (A and C), (B and C) or (A, B and C).

What is claimed is:

1. A management system comprising:
a first consuming device to which a consumable can be provided; and
a server configured to perform delivery management of the consumable under an agreement,
wherein the first consuming device is configured to perform:
a consuming process including consuming a contract consumable provided to the first consuming device, the contract consumable being subject to the delivery management under the agreement for the first consuming device, and
wherein at least one of the first consuming device and the server is configured to perform:
a delivery requesting process including issuing a delivery request for a new contract consumable;
a delivery information storing process including storing delivery information indicating a delivery status of the new contract consumable corresponding to the delivery request issued in the delivery requesting process;
a provision information storing process including storing provision information indicating a provision status of the new contract consumable that has been delivered;
an obtaining process including obtaining the delivery information stored in the delivery information storing process and the provision information stored in the provision information storing process;
a determination process including determining whether an unused contract consumable that has been delivered exists based on the delivery information and the provision information obtained in the obtaining process; and
in response to determining in the determination process that the unused contract consumable exists, a notification process including outputting a notification prompting use of the unused contract consumable with the first consuming device.

2. The management system according to claim 1,
wherein the storing included in the delivery information storing process stores, as the delivery information, a number of deliveries indicating a total number of new contract consumables delivered in response to the delivery request issued in the delivery requesting process,
wherein the storing included in the provision information storing process stores, as the provision information, a number of provisions indicating a total number of times a new contract consumable is provided to the first consuming device,
wherein the determining included in the determination process determines whether the number of deliveries is greater than the number of provisions, and
wherein the outputting included in the notification process outputs the notification in response to determining in the determination process that the number of deliveries is greater than the number of provisions.

3. The management system according to claim 1,
wherein the outputting included in the notification process is performed when a new agreement is entered into after the agreement has been canceled.

4. The management system according to claim 1, further comprising:
a second consuming device different from the first consuming device,
wherein at least one of the second consuming device and the server is configured to perform, when replacement information indicating that the first consuming device has been replaced with the second consuming device is stored on the server under the agreement for the first consuming device:
the obtaining process including obtaining the delivery information and the provision information on the first consuming device;
the determination process using the delivery information and the provision information on the first consuming device obtained in the obtaining process; and
in response to determining in the determination process that the unused contract consumable exists, the notification process including outputting a notification prompting use of the unused contract consumable with the second consuming device.

5. The management system according to claim 1,
wherein the determination process further includes determining, in response to determining that the unused contract consumable exists, whether the unused contract consumable has passed an expiration date using a value related to a usable period, and
wherein the notification process is performed in response to determining in the determination process that the unused contract consumable exists and has not passed the expiration date.

6. The management system according to claim 1,
wherein a plurality of types of consumables can be provided to the first consuming device,
wherein the at least one of the first consuming device and the server performs the delivery requesting process, the delivery information storing process, the provision information storing process, the obtaining process, the determination process, and the notification process for each type of the plurality of types, and
wherein when the determining included in the determination process determines that the unused contract consumable exists for a specific type among the plurality of types, the outputting included in the notification process outputs the notification prompting use of the unused contract consumable of the specific type.

7. The management system according to claim 1,
wherein the at least one of the first consuming device and the server performs the delivery requesting process in response to determining in the determination process that the unused contract consumable does not exist.

8. The management system according to claim 1,
wherein the notification outputted in the notification process further provides a guidance how to proceed when the unused contract consumable does not exist.

9. The management system according to claim 1,
wherein the first consuming device performs, as the at least one of the first consuming device and the server, the obtaining process, the determination process, and the notification process.

10. A consuming device communicable with a server, the server being configured to perform delivery management of a consumable under an agreement, the consumable can be provided to the consuming device, the consuming device comprising:
a controller configured to perform:
a consuming process including consuming a contract consumable provided to the consuming device, the contract consumable being subject to the delivery management under the agreement for the consuming device;
a delivery requesting process including issuing a delivery request for a new contract consumable;
a delivery information storing process including storing delivery information indicating a delivery status of a new contract consumable corresponding to the delivery request issued in the delivery requesting process;
a provision information storing process including storing provision information indicating a provision status of the new contract consumable that has been delivered;
an obtaining process including obtaining the delivery information stored in the delivery information storing process and the provision information stored in the provision information storing process;
a determination process including determining whether an unused contract consumable that has been delivered exists based on the delivery information and the provision information obtained in the obtaining process; and
in response to determining in the determination process that the unused contract consumable exists, a notification process including outputting a notification prompting use of the unused contract consumable with the consuming device.

11. A server communicable with a consuming device to which a consumable can be provided, the server being configured to perform delivery management of the consumable under an agreement, the consuming device being configured to perform a consuming process including consuming a contract consumable provided to the consuming device, the contract consumable being subject to the delivery management under the agreement for the consuming device, the server comprising:
a controller configured to perform:
a delivery requesting process including issuing a delivery request for a new contract consumable;
a delivery information storing process including storing delivery information indicating a delivery status of a new contract consumable corresponding to the delivery request issued in the delivery requesting process;
a provision information storing process including storing provision information indicating a provision status of the new contract consumable that has been delivered;
an obtaining process including obtaining the delivery information stored in the delivery information storing process and the provision information stored in the provision information storing process;
a determination process including determining whether an unused contract consumable that has been delivered exists based on the delivery information and the provision information obtained in the obtaining process; and
in response to determining in the determination process that the unused contract consumable exists, a notification process including outputting a notification prompting use of the unused contract consumable with the consuming device.

12. A method of managing a management system, the management system including: a consuming device to which a consumable can be provided; and a server configured to perform delivery management of the consumable under an agreement, the method comprising:
the consuming device performing:
a consuming process including consuming a contract consumable provided to the consuming device, the contract consumable being subject to the delivery management under the agreement for the consuming device; and
at least one of the consuming device and the server performing:
a delivery requesting process including issuing a delivery request for a new contract consumable;
a delivery information storing process including storing delivery information indicating a delivery status of the new contract consumable corresponding to the delivery request issued in the delivery requesting process;
a provision information storing process including storing provision information indicating a provision status of the new contract consumable that has been delivered;
an obtaining process including obtaining the delivery information stored in the delivery information storing process and the provision information stored in the provision information storing process;
a determination process including determining whether an unused contract consumable that has been delivered exists based on the delivery information and the provision information obtained in the obtaining process; and
in response to determining in the determination process that the unused contract consumable exists, a notification process including outputting a notification prompting use of the unused contract consumable with the consuming device.
